(19) United States
(12) Patent Application Publication
(10) Pub. No.: US 2024/0208848 A1
(43) Pub. Date: Jun. 27, 2024

(54) REMOVAL MATERIAL DESTRUCTION BY SUPERCRITICAL WATER OXIDATION FOR PFAS REMOVAL

(71) Applicant: EVOQUA WATER TECHNOLOGIES LLC, Pittsburgh, PA (US)

(72) Inventors: Simon Paul Dukes, Chelmsford, MA (US); Savvas Hadjikyriacou, Tyngsboro, MA (US)

(21) Appl. No.: 18/580,974

(22) PCT Filed: Jul. 13, 2022
(86) PCT No.: PCT/US2022/036983

§ 371 Date: Jan. 19, 2024

Related U.S. Application Data
(60) Provisional application No. 63/221,284, filed on Jul. 13, 2021.
(60) Provisional application No. 63/224,034, filed on Jul. 21, 2021.

(51) Int. Cl. C02F 9/00; C02F 1/02; C02F 1/28; C02F 1/44; C02F 1/72; C02F 101/10; C02F 101/16; C02F 101/36

(52) U.S. Cl. CPC C02F 9/00; C02F 1/02; C02F 1/283; C02F 1/285; C02F 1/44; C02F 1/72; C02F 2101/101; C02F 2101/16; C02F 2101/36; C02F 2303/16

(57) ABSTRACT

Methods of treating water containing PFAS are disclosed. The methods include dosing water containing PFAS with a removal material, e.g., adsorption media, to promote loading of the removal material, e.g., adsorption media, with PFAS. The methods include producing a slurry stream including the PFAS-loaded removal material. e.g., adsorption media. The methods include subjecting the slurry stream to a supercritical water oxidation (SCWO) process. The SCWO process is driven at least in part by a predetermined calorific value of the removal material, e.g., adsorption media. Systems for treating water containing PFAS are also disclosed. Systems include a contact reactor containing removal material. e.g., adsorption media; a source of water comprising PFAS fluidly connected to an inlet of the contact reactor; a separation system fluidly connected downstream of the contact reactor; and SCWO reactor fluidly connected downstream of the separation system.

### CROSS-REFERENCE TO RELATED APPLICATIONS

This application claims priority under 35 U.S.C. § 119(e) to U.S. Provisional Application Ser. No. 63/221,284, titled “Powdered Activated Carbon Destruction by Supercritical Water Oxidation for PFAS Removal,” filed on Jul. 13, 2021 and U.S. Provisional Application Ser. No. 63/224,034, titled “Application of Cyclodextrins for Perfluoroalkyl Substances Removal,” filed Jul. 21, 2021, the disclosures of which are each incorporated herein by reference in their entirety for all purposes.

### FIELD OF TECHNOLOGY

Aspects and embodiments disclosed herein are generally related to the field of the removal and elimination of per- and polyfluoroalkyl substances (PFAS) from water.

### SUMMARY

In accordance with an aspect, there is provided a method of treating water containing per- and polyfluoroalkyl substances (PFAS). The method may include dosing water containing PFAS with adsorption media to promote loading of the adsorption media with PFAS. The method further may include producing a slurry stream including the PFAS-loaded adsorption media. The method additionally may include subjecting the slurry stream to a supercritical water oxidation (SCWO) process.

In some embodiments, the PFAS include one or more of perfluorooctane sulfonic acid (PFOS) and perfluorooctanoic acid (PFOA).

In some embodiments, the adsorption media is a carbon-based media. For example, the carbon-based adsorption media may include activated carbon, e.g., powdered activated carbon (PAC) or granular activated carbon (GAC). In particular embodiments, the carbon-based adsorption media may be PAC. In certain embodiments, the carbon-based adsorption media may include macrocyclic organic compounds such as cyclodextrins, e.g., α-cyclodextrin, γ-cyclodextrin, and γ-cyclodextrin. In other embodiments, the carbon-based adsorption media may include heterocyclic molecules, e.g., porphyrins, diatomaceous earth, or neutral and ionic surfactants. In some embodiments, the adsorption media may be inorganic, e.g., alumina, e.g., activated alumina, aluminosilicates and their metal-coordinated forms, e.g., zeolites, silica, perlite, ion exchange resins, and other similar inorganic materials capable of interacting with and subsequently removing contaminants and pollutants from the water containing PFAS

In some embodiments, the slurry stream including the loaded adsorption media is produced via a filtration and backwash operation. In further embodiments, the method may include concentrating the slurry stream prior to the SCWO process. In further embodiments, the method may include concentrating the water containing PFAS prior to dosing with adsorption media, e.g., using a membrane concentrator. For example, concentrating the water containing PFAS may provide for a concentration increase of PFAS of at least 20× in the water to be treated relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×.

In further embodiments, the method may include introducing a selective ion to the SCWO process. The selective ion may be chosen to interact with one or more residual compounds remaining following the SCWO process to render it safe for disposal.

In further embodiments, the method may include adjusting an amount of adsorption media based on at least one quality parameter of the water to be treated. For example, the at least one quality parameter may include a target concentration of the PFAS in the treated water to be at or below a specified regulatory threshold.

In further embodiments, the method may include adjusting a flow rate of the slurry stream and/or an oxygen supply level associated with the SCWO process.

In some embodiments, the SCWO process is operated at a temperature of at least about 374° C. and a pressure of at least about 221 bar, e.g., greater than or equal to the critical point of water.

In some embodiments, the SCWO process is operated under autothermal conditions, i.e., no outside input of heat is required. In further embodiments, the method may include preheating the water containing PFAS and/or the slurry stream upstream of the SCWO process.

In further embodiments, the method may include introducing a product stream, e.g., from the SCWO process, to a downstream unit operation for further treatment.

In further embodiments, the method may include separating byproducts including nitrogen oxides (NOₓ) and/or sulfur oxides (SOₓ) and/or inorganic ash from product water at an outlet of the SCWO process.

In some embodiments, the method may be associated with as PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

In accordance with an aspect, there is provided a method of treating water containing PFAS. The method may include promoting loading of PFAS from the water containing PFAS onto a removal material having a predetermined calorific value. The method further may include creating a slurry stream including the removal material loaded with PFAS. The method additionally may include subjecting the slurry stream to a SCWO process driven at least in part by a predetermined calorific value of the slurry stream.

In accordance with an aspect, there is provided a system for treating water containing PFAS. The system may include a contact reactor containing adsorption media, a source of water comprising PFAS fluidly connectable to an inlet of the contact reactor, a separation system fluidly connectable downstream of the contact reactor, and a SCWO reactor fluidly connectable downstream of the separation system.

In some embodiments, the adsorption media is bifunctional with respect to facilitating PFAS removal and driving the SCWO reactor, e.g., the adsorption material can oxidize in the SCWO process.

In some embodiments, the adsorption media includes at least one material selected from the group consisting of: activated carbon, cyclodextrins, heterocyclic molecules, porphyrins, diatomaceous earth, neutral surfactants, ionic surfactants, inorganic media, alumina, activated alumina, aluminosilicates, zeolites, silica, perlite, metal-organic complexes, e.g., metal-organic frameworks, e.g., MOFs, and ion exchange resins.

In some embodiments, the separation system may include a dynamic membrane. For example, in particular embodiments, the dynamic membrane may be a ceramic membrane.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIGS. 1A-1C illustrate representations of cyclodextrins suitable as a removal medium for systems and method disclosed herein. FIG. 1A illustrates the chemical structure of a D-glucopyranose monomer used to form all cyclodextrins (left) and the γ-CD toroidal structure of a cyclodextrin (right). FIG. 1B illustrates the formation of a host-guest complex with a cyclodextrin. FIG. 1C illustrates an example of a cross-linked cyclodextrin;

FIG. 2 illustrates a system for treating water containing PFAS, according to an embodiment;

FIG. 3 illustrates a system for treating water containing PFAS, according to another embodiment; and

FIG. 4 illustrates a system for treating water containing PFAS, according to another embodiment.

### DETAILED DESCRIPTION

There is rising concern about the presence of various contaminants in municipal wastewater, surface water, drinking water, and groundwater. For example, perchlorate ions in water are of concern, as well as PFAS and PFAS precursors, along with a general concern with respect to total organic carbon (TOC).

PFAS are man-made chemicals used in numerous of industries. PFAS molecules typically do not break down naturally. As a result, PFAS molecules accumulate in the environment and within the human body. PFAS molecules contaminate food products, commercial household and workplace products, municipal water, agricultural soil and irrigation water, and even drinking water. PFAS molecules have been shown to cause adverse health effects in humans and animals.

PFAS are organic compounds consisting of fluorine, carbon and heteroatoms such as oxygen, nitrogen and sulfur. PFAS is a broad class of molecules that further includes polyfluoroalkyl substances. PFAS are carbon chain molecules having carbon-fluorine bonds. Polyfluoroalkyl substances are carbon chain molecules having carbon-fluorine bonds and also carbon-hydrogen bonds. Common PFAS molecules include perfluorooctanoic acid (PFOA), perfluorooctanesulfonic acid (PFOS), and short-chain organofluorine chemical compounds, such as the ammonium salt of hexafluoropropylene oxide dimer acid (HFPO-DA) fluoride (also known as GenX). PFAS molecules typically have a tail with a hydrophobic end and an ionized end. The hydrophobicity of fluorocarbons and extreme electronegativity of fluorine give these and similar compounds unusual properties. Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. PFAS are commonly use as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, serious efforts to limit the environmental release of PFAS are now commencing.

It may be desirable to have flexibility in terms of what type of media is used for water treatment within a stream of water. For example, the source and/or constituents of the process water to be treated may be a relevant factor. Various federal, state and/or municipal regulations may also be factors. The U.S. Environmental Protection Agency (EPA) developed revised guidelines in May 2016 of a combined lifetime exposure of 70 parts per trillion (PPT) for PFOS and PFOA. Federal, state, and/or private bodies may also issue relevant regulations. In some embodiments, other approaches for PFAS removal, such as the use of ion exchange resin, may be used in conjunction with activated carbon treatment as described herein. Market conditions may also be a controlling factor. These factors may be variable and therefore a preferred water treatment approach may change over time.

Thus, in accordance with one aspect, there is provided a method of treating water containing PFAS. The water may contain at least 10 ppt PFAS, for example, at least 1 ppb PFAS. For example, the waste stream may contain at least 10 ppt-1 ppb PFAS, at least 1 ppb-10 ppm PFAS, at least 1 ppb-10 ppb PFAS, at least 1 ppb-1 ppm PFAS, or at least 1 ppm-10 ppm PFAS.

In certain embodiments, the water to be treated may include PFAS with other organic contaminants. One issue with treating PFAS compounds in water is that the other organic contaminants compete with the various processes to remove PFAS. For example, if the level of PFAS is 80 ppb and the background TOC is 50 ppm, a conventional PFAS removal treatment, such as an activated carbon column, may exhaust very quickly. Thus, it may be important to remove TOC prior to treatment to remove PFAS.

Thus, in some embodiments, the systems and methods disclosed herein may be used to remove background TOC, prior to treating the water for removal of PFAS. The methods may be useful for oxidizing target organic alkanes, alcohols, ketones, aldehydes, acids, or others in the water. In some embodiments, the water containing PFAS further may contain at least 1 ppm TOC. For example, the water containing PFAS may contain at least 1 ppm-10 ppm TOC, at least 10 ppm-50 ppm TOC, at least 50 ppm-100 ppm TOC, or at least 100 ppm-500 ppm TOC.

In some embodiments, the removal material, e.g., adsorption media, used to remove the PFAS can be any suitable removal material, e.g., adsorption media, that can interact with the PFAS in the water to be treated and effectuate its removal, e.g., by being loaded onto the removal material. In general, the removal materials, e.g., adsorption media, disclosed herein is bifunctional with respect to facilitating PFAS removal and driving downstream treatment processes, such as combustion or oxidation. Carbon-based removal materials, e.g., activated carbon, and resin media are both widely used for the removal of organic and inorganic contaminates from water sources. For example, activated carbon may be used as an adsorbent to treat water. In some embodiments, the activated carbon may be made from bituminous coal, coconut shell, or anthracite coal. The activated carbon may generally be a virgin or a regenerated activated carbon. In some embodiments, the activated carbon may be a modified activated carbon. The activated carbon may be present in various forms, i.e., a granular activated carbon (GAC) or a powdered activated carbon (PAC). Without wishing to be bound by any particular theory, PAC typically has a larger surface area for adsorption that GAC and can be agitated and flowed more easily, increasing its effective use. Various activated carbon media for water treatment are known to those of ordinary skill in the art. In at least some non-limiting embodiments, the media may be an activated carbon as described in U.S. Pat. Nos. 8,932,984 and/or 9,914,110, both to Evoqua Water Technologies LLC.

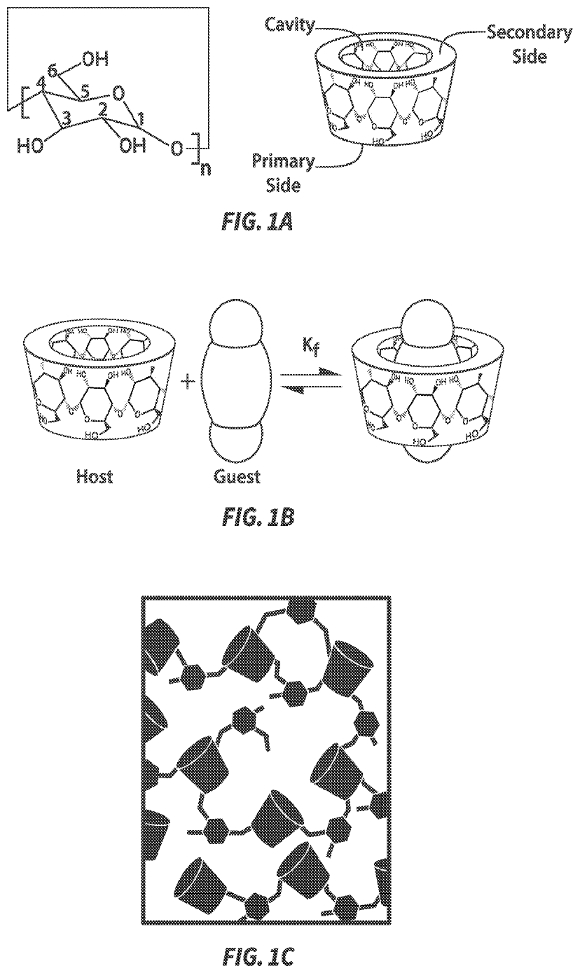

In some embodiments, the removal material used to remove the PFAS can be cyclodextrins. Cyclodextrins are macrocyclic molecules that are composed of D-glucopyranose monomers that are linked by α-1,4 bonds together in a ring shape, formally known as a γ-CD toroidal structure. The most common cyclodextrins are denoted α, β, and γ, which are made up of 6, 7 and 8 monomers, respectively. Being formed from D-glucopyranose monomers, cyclodextrins include uncoordinated hydroxyl functional groups on the outside that are available for further chemical reaction, such as derivatization. Derivatization can be used to adjust the selectivity for certain classes of molecules. The macrocycles form structures that resemble a truncated cone, as illustrated in FIG. 1A. The formation of the truncated cone-shaped ring forms a cavity in the center of the macrocycle; this cavity can accommodate another molecule therein, and the chemistry of this cavity can be exploited for use as a water soluble adsorbent. In general and based on the truncated cone shaped ring and pendant hydroxyl groups, the outside of the macrocycle has a greater hydrophilicity than the inside of the macrocycle. The difference in hydrophilicity of the macrocycle permits its use as an adsorbent for organic molecules and other ions that can react or interact with the hydroxyl groups can get trapped inside the cavity and be removed from water the macrocycle is dissolved in. The hydroxyl groups of the D-glucopyranose monomers can be functionalized to improve the selectivity of the resulting cyclodextrin on the whole, with further modifications to improve selectivity for long chain PFAS molecules or short chain PFAS molecules.

Cyclodextrins containing a molecule inside its internal cavity are called inclusion complexes or host-guest complexes, of which a general depiction of an inclusion complex is illustrated in FIG. 1B. These inclusion complexes are stabilized by intermolecular forces including hydrophilic-hydrophobic interactions, polar interactions, hydrogen bonds, and covalent bonds. The unique property of cyclodextrins to form inclusion complexes has been exploited various industries such as excipients for drug delivery, chromatography media, and consumer products such as cosmetics and odor removal compounds. The guest molecule within the macrocycle can be released from the host using the application of heat, destruction of the cyclodextrin structure, and by solvolysis, among other methods known to one of skill in the art.

Cyclodextrins can be used as a removal material for PFAS in water streams without additional functionalization to the pendant hydroxyl groups. Alternatively, the pendant hydroxyl groups of the macrocycle can undergo chemical reactions, such as crosslinking or coordination with metal atoms, to form larger, structures that can be used as removal materials. In some non-limiting embodiments, cyclodextrins can be cross-linked with a suitable crosslinking agent to form insoluble polymers having an increased loading capacity for PFAS and other molecules. FIG. 1C illustrates an example of a cross-linked cyclodextrin. In other non-limiting embodiments, cyclodextrins can be coordinated to alkali metal cations such as potassium (K⁺), sodium (Na⁺), cesium (Cs⁺) and others. The selection of cyclodextrin and the alkali metal ion, provides for the formation of diverse coordination structures, herein called cyclodextrin-metal organic frameworks (CD-MOFs). The alkali-metals through the hydroxyl groups coordinate with multiple units of cyclodextrin, resulting in the formation of highly porous crystalline structures. These metal-cyclodextrin hybrid structures can trap and isolate various molecules, both organic and inorganic. Since these CD-MOFs are insoluble in the water, they can be used as a removal material for pollutants or contaminants in a water stream, e.g., PFAS. The pollutants and contaminants trapped by the CD-MOFs can be removed filtration of the CD-MOFs and subsequent release from the CD-MOFs by treatment with a solvent, heat, or another process. Alternatively, the CF-MOFs with trapped pollutants and contaminants can be destroyed by other processes, such as advanced oxidation or combustion.

The removal material as described herein is not limited to particulate media, e.g., activated carbons, or cyclodextrins. Any suitable removal material, e.g., adsorption media, may be used to adsorb or otherwise bind with pollutants and contaminants present in the waste stream, e.g., PFAS. For example, suitable removal material may include, but are not limited to, alumina, e.g., activated alumina, aluminosilicates and their metal-coordinated forms, e.g., zeolites, silica, perlite, diatomaceous earth, surfactants, ion exchange resins, and other organic and inorganic materials capable of interacting with and subsequently removing contaminants and pollutants from the waste stream.

One method that has begun to see use in the wastewater treatment field is supercritical water oxidation (SCWO). In SWCO, water is heated and pressurized to a point past its critical point where vapor and liquid phases can coexist, and the resulting supercritical fluid is used as an oxidant along with O₂ gas that dissolves into the supercritical water. For water, the critical point occurs at a temperature and pressure are above 374° C. and 221 bar, respectively, and in some embodiments, systems and methods of disclosure are operated at temperatures and pressures equal to and/or above these values. A unique property of supercritical water is that the solubility of gases and organic compounds is increased to close to full solubility while inorganic compounds become almost insoluble. Thus, gases and organic compounds entering a SCWO process undergo near-complete destruction into carbon dioxide and water. Further, the lower overall temperature of the reaction, i.e., less than 374° C., reduces the formation of unwanted byproducts such as hydrofluoric acid (HF), nitrogen oxides (NOₓ) and sulfur oxides (SOₓ) that would require additional separation. The removal of these waste products, should they form, can be performed by methods known in the art.

SCWO is generally a fully enclosed process and the reaction products are discharged at standard atmospheric pressures and temperatures, i.e., 1 atmosphere and 25° C. As discussed herein, the resulting products of SCWO are largely benign, consisting mainly of CO₂, water, and N₂. As the purity of these products is high coming out of a SCWO reactor, there is no need for scrubbing or other treatment processes to make them suitable for discharge to the environment. Waste streams including organic and inorganic halogens are converted to the corresponding haloacids, and organic and inorganic sulfur species are converted to sulfuric acid. These species are generally easier to remove from a liquid stream than as gases such as SO₂. Heavy metals in the waste stream are oxidized to their highest oxidation state and are separated together with any inert materials as a fine, non-leachable ash which can be used much like power station ash for landscaping, aggregates and similar applications, or simply landfilled.

In certain non-limiting embodiments, this disclosure describes water treatment systems for removing PFAS from water and methods of treating water containing PFAS. Systems described herein include a contact reactor containing a removal material, e.g., an adsorption media, that has an inlet fluidly connected to a source of water containing PFAS. The removal material, after being exposed to PFAS and removing it from the water, e.g., by becoming loaded with PFAS, is directed from an outlet of the contact reactor to an inlet of a separation system positioned downstream of the contact reactor. The separation system separates treated water, i.e., water containing a lower concentration of PFAS than the source water, and the removal material, e.g., adsorption media. The removal material, e.g., adsorption media can be directed to an inlet of a SCWO reactor positioned downstream of the separation system.

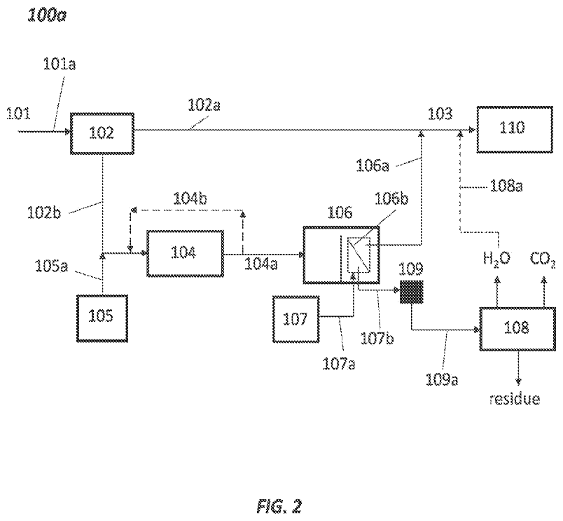

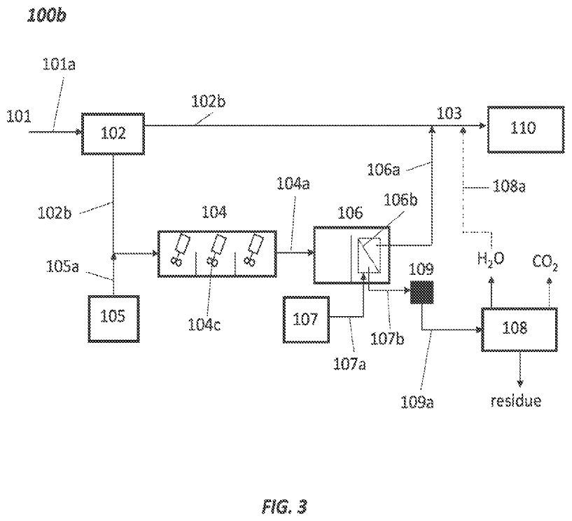

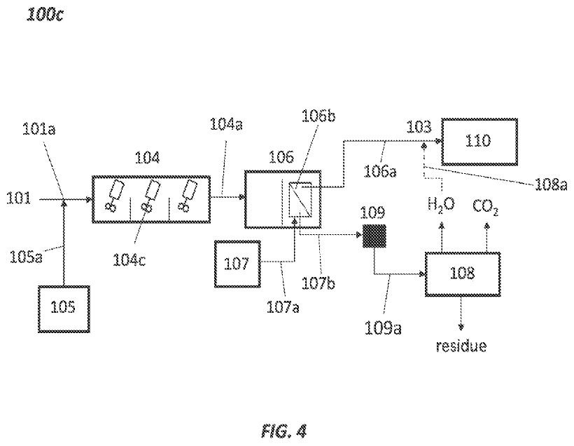

Embodiments of a water treatment system for PFAS removal and destruction are illustrated in FIGS. 2-4. In FIGS. 2 and 3, system 100a and 100b include source of water 101 connectable by conduit 101a to an inlet of an upstream separation system 102 that can produce a treated water 103 and a stream enriched in PFAS. The first separation system 102 can be any suitable separation system that can produce a stream enriched in PFAS or other compounds. For example, the upstream separation system 102 can be a reverse osmosis (RO) system, a nanofiltration (NF) system, an ultrafiltration system (UF), or electrochemical separations methods, e.g., electrodialysis, electrodeionization, etc. In such implementations, the reject, retentate or concentrate streams from these types of separation systems will include water enriched in PFAS. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×. In some embodiments of the system, such as system 100c illustrated in FIG. 4, water from the source of water 101, or another source of PFAS containing water, can be directed into the contact reactor 104 via conduit 101a without the need for upstream separation to produce a stream of water enriched in PFAS.

With continued reference to FIGS. 2-4, the stream containing PFAS is directed into contact reactor 104 via conduit 102b where it contacts a removal material held within the contact reactor 104. The removal material, e.g., adsorption media, may be delivered to contact reactor 104 from a source of removal material 105 by conduit 105a. In some embodiments, water may be mixed with removal material before entering the contact reactor. In some embodiments, the water is added to a contact reactor that initially includes a mass or volume of removal material. In some embodiments, the water is directed into the contact reactor and the removal media is then added to the water-filled contact reactor. As described herein, the removal material may be a carbonaceous adsorption media, such as PAC, GAC, or cyclodextrins, heterocyclic molecules, e.g., porphyrins, diatomaceous earth, or neutral and ionic surfactants or an inorganic media, e.g., alumina, e.g., activated alumina, aluminosilicates and their metal-coordinated forms, e.g., zeolites, silica, perlite, ion exchange resins, and other similar inorganic materials. With reference to embodiments involving solid carbon-based media, e.g., PAC and cyclodextrins, as the water containing PFAS moves through the removal material, PFAS and other contaminants may be adsorbed via movement from the water to the removal material to promote loading of the removal material, e.g., adsorption media. In some embodiments, the overall removal, e.g., adsorption, process may be dominated by a mass transfer step from the water bulk to the surface of the media, through the boundary layer surrounding the media particles. Internal diffusion through the pores of the removal material, adsorption onto the surface of the particle, or host-guest interactions may also be involved.

FIGS. 2-4 illustrate different embodiments of contact reactors 104 suitable is systems of this disclosure. In FIG. 2, contact reactor 104 is a plug flow contact reactor where water flow through the reactor is in “plugs” with each “plug” having a different composition than the preceding plug as the plugs pass through the removal material within the plug flow contact reactor. A plug flow contact reactor may include an optional recycle line 104b to directed all or a portion of the water passing through it back to its inlet if further treatment of the water is needed, e.g., to meet an internal water quality parameter or a regulatory standard. As illustrated in FIGS. 3 and 4, contact reactor 104 is a continuous stirred tank reactor having mixing elements 104c that mix the removal material, e.g., adsorption media, with the water containing PFAS. The removal material may be added to the water containing PFAS prior to the entering the contact reactor 104 as illustrated in FIGS. 3 and 4 where source of removal material 105 has a conduit 105a fluidly coupled to conduit 101a carrying water containing PFAS. Continuous stirred tank reactors may include multiple mixing elements 104c and internal recycle systems to enhance removal of PFAS and other pollutants using the removal material, e.g., adsorption media. The amount of removal material, e.g., adsorption media, within the contact reactor 104 may be adjusted based on at least one quality parameter of the water to be treated. For example, the amount of removal material, e.g., adsorption media, used in the contact reactor 104 may scale approximately linearly with a measured amount of PFAS in the water to be treated. In some embodiments, water quality parameters, such as the PFAS concentration in treated water, may determine how much removal material, e.g., adsorption media, is to be added to the contact reactor 104. Alternatively, or in addition, one or more additional water quality parameters, such as water composition, water pH, water temperature, water flow rate, water conductivity, water TSS, water TDS, water ORP, and/or water TOC may be used to determine how much removal material, e.g., adsorption material, is to be added to the contact reactor 104 and for how long the water containing PFAS is to be mixed with the removal material.

With continued reference to FIGS. 2-4, the stream containing the removal material, e.g., adsorption media, and water is directed from an outlet of the contact reactor 104 by conduit 104a into a downstream separation system 106. The downstream separation system 106 is used to remove treated water 103 that is substantially free of PFAS and collect the solid removal material, e.g., adsorption media. The downstream separation system 106 can be any suitable separation system having separation elements that can collect the removal material, e.g., adsorption media, from the stream to concentrate the PFAS in the stream to improve its removal. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×. In certain embodiments, the downstream separation system 106 is a membrane separation system with membrane 106b where the PFAS-loaded removal material, e.g., adsorption media, collects on the membranes and treated water 103 is discharged. In specific embodiments, the membrane separation system may include a dynamic membrane. In a dynamic membrane system, water containing the removal material is forced past the submerged membrane which accumulates on the surface of the membrane. The accumulation of the removal material on the membrane creates a large surface area removal system using the underlying membrane as a porous support where additional contaminants from the water, e.g., PFAS, can be further removed by now-available capacity of the removal material spread over the surface area of the supporting membrane. Membranes suitable for this purpose have pore sizes that permit trapping of the removal material on the membrane surface and sufficient mechanical strength to not rip, tear, or crack when subjected to the force of water being passed therethrough and when the mass of removal material begins to collect on the membrane surface. In some embodiments, the dynamic membrane is a ceramic membrane.

To remove the collected PFAS-loaded removal material, e.g., adsorption media, the separation elements of the downstream separation system 106 can be backwashed to release the PFAS-loaded removal material to form a slurry stream. The water for backwashing the separation elements may come from a source of backwash water 107 fluidly coupled to the downstream separation system 106 via conduit 107a. The water from source of backwash 107 can be any suitable source of water and in general is water of lower quality so as to not excessively use highly treated water for cleaning and maintenance purposes. In some embodiments, treated water 103 from the system 100a, 100b, and 100c may be recycled for use as backwash water if desired. For membrane separators, the backwashing period to form the slurry stream may be determined a length of time the membrane has been in service, a change in pressure of the water being passed through the membrane, a water quality parameter, or another factor indicative that the membrane is past its service life. The backwash process may occur automatically, e.g., a set or fixed schedule or as needed, e.g., controlled by a controller with inputs including appropriate sensors and outputs including valves, or manually by an end user or operator.

With continued reference to FIGS. 2-4, the slurry stream coming from the downstream separation system 106 containing PFAS-loaded removal material is directed via conduit 107b to an inlet of a SCWO reactor 108 where the slurry stream is used as the fuel for the SWCO reactor 108. Prior to the SCWO reactor 108 beginning its cycle, a selective ion may be added to the slurry stream to coordinate with or sequester any potential reactions that may occur within the SCWO reactor 108. For example, PFAS contain large amounts of fluorine which has the potential to produce hydrofluoric acid (HF) that can damage the SCWO reactor 108. The addition of a selective ion, such as calcium (Ca²⁺), e.g., calcium gluconate or other soluble calcium salt, to form a stable mineral product can remove excess fluorine from the SCWO reactor 108. The oxidation process in the SCWO reactor 108 destroys the PFAS-loaded removal material, producing condensed water, carbon dioxide (CO₂) gas, reactive gases, e.g., SOₓ and NOₓ, and residual ash that did not combust during the oxidation process. As discussed herein, the condensate water and the CO₂ produced from the SCWO process are of high purity and can be discharged out of the system 100a, 100b, 100c without additional treatment. In some embodiments, the condensate water may be directed to the treated water 103 of the system 100a, 100b, 100c via conduit 108a should its quality be sufficient. The ash and reactive gases, e.g., NOₓ and SOₓ, that are produced as byproduct can be dealt with in an appropriate manner. The ash can be recycled for mineral content or disposed of in a landfill. The gases can be collected and scrubbed as needed or used for acid production.

As discussed herein, SCWO is an energy intensive process that can proceed under autoignition, e.g., autothermal, conditions once the requisite temperature and pressure conditions are satisfied. Additional heat may be needed to reach the autoignition or autothermal point. In some embodiments, the system 100a, 100b, and 100c includes a heater 109 positioned between the outlet of the downstream separation system 106 via conduit 107b and the SCWO reactor 108 to increase the temperature of the slurry stream entering the SCWO reactor 108 if the calorific value, i.e., heat of combustion, of the slurry stream is insufficient to permit the SCWO reactor 108 to operate under autothermal conditions. The heater 109 may be any suitable heater, such as a resistive heater, heat exchanger, tube-in-tube heater, or other similar heating device. Upon heating, the heated slurry stream is delivered to the SCWO reactor 108 by conduit 109a. For passive heaters, e.g., heat exchangers, existing waste heat from the SCWO reactor 108 may be used to heat the slurry stream entering the SCWO reactor 108 via dissipation through the heat exchanger. The use of a heat exchanger makes the process more energy efficient, compact, and extends service life of the SCWO 30) reactor 108.

As discussed herein, SCWO is an autothermal, or self-sustaining, oxidation process once the SCWO reactor is up to operating temperature. Prior to achieving operating temperature, the input of energy is required to heat and pressurize the water. This energy input has until recently limited the large scale use of SCWO. Like other related combustion technologies, the source of fuel for the autothermal reaction, e.g., a removal material, e.g., adsorption media, laden with adsorbed pollutants like PFAS, requires a modest concentration of organic matter to reach the autoignition point, approximately about 4-5% by mass. If the slurry stream being fed to the SCWO reactor has an insufficient calorific value, e.g., heat of combustion, the SCWO will require external heating in order to operate, such as by a direct source of heat specific to the SCWO reactor or a device to collect waste heat from its location, e.g., heater 109 in FIGS. 2-4 preheating the slurry stream entering the SCWO reactor 108. Without wishing to be bound by any particular theory, there exists a relationship between the physical density of the waste stream used as fuel for the SCWO reactor and operating the reactor itself. In general, fuel of maximum calorific value, i.e., density, is desirable to reach the autothermal point. The fuel used in a SWCO reactor is generally a slurry stream of organic solids and organic liquids. If the slurry stream is too dense, the SCWO reactor distribution components may clog or otherwise become too rich in fuel and operate inefficiently. Should the slurry stream be too thin, the calorific value for the slurry stream may be too low for the reactor to reach the autoignition point, thus requiring the input of energy, e.g., from heater 109, and lowering the overall efficiency of a treatment system incorporating SCWO. Similarly, the concentration of PFAS may be increased before SCWO to improve efficiency; this may be achieved by additional concentration of the PFAS using separation device as disclosed herein, e.g., RO, NF, or dissolved air flotation (DAF), or the like. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×. Therefore, there exists a balance between treatment volume, fuel processing, treatment efficacy, and cost that is to be considered when determining the choice of removal materials, upstream treatment systems, and decisions from regulatory agencies for use of SCWO reactors. In some embodiments, the flow rate of the slurry stream and/or an oxygen supply level associated with the SCWO process within the SCWO reactor 108 may be adjusted to account for the variations in calorific value of the slurry stream. Without wishing to be bound by any particular theory, for slurry streams of a higher density, a greater flow rate of slurry stream into the SCWO reactor and/or increased flow from an oxygen supply may be used to offset the increased density of slurry, which can promote oxidation and reduce clogging of internal components of the SCWO reactor.

With continued reference to FIGS. 2-4, the treater water 103 produced from the system 100a, 100b, and 100c is discharged by conduit 102a in FIGS. 2 and 3 and conduit 106a in FIG. 4. If the purity of the treated water 103 is sufficient, the treated water 103 can be discharged as-is. In some embodiments, the treated water 103 is discharged as a product stream to a downstream unit operation 110 for further treatment. The downstream unit operation 110 can be any suitable unit operation, such as pressure-driven separation, e.g., NF or UF, electrically driven separation, e.g., electrodialysis (ED), electrodialysis reversal (EDR), electrochemical deionization, capacitive deionization, continuous electrodeionization (CEDI), and reversible continuous electrodeionization (RCEDI), advanced oxidation process (AOP), e.g., ultraviolet (UV) irradiation (UV-AOP), ultrasonic cavitation, electrochemical AOP, or any other downstream unit operation 110. This disclosure is in no way limited by the selection of a downstream unit operation 110.

The treated water 103 produced by the system 100a, 100b, and 100c may be substantially free of the PFAS. The treated water 103 being “substantially free” of the PFAS may have at least 90% less PFAS by volume than the waste stream. The treated water 103 being substantially free of the PFAS may have at least 92% less, at least 95% less, at least 98% less, at least 99% less, at least 99.9% less, or at least 99.99% less PFAS by volume than the waste stream. Thus, in some embodiments, the systems and methods disclosed herein may be employed to remove at least 90% of PFAS by volume from the source of water 101. The systems and methods disclosed herein may remove at least 92%, at least 95%, at least 98%, at least 99%, at least 99.9%, or at least 99.99% of PFAS by volume from the source of water 101. In certain embodiments, the systems and methods disclosed herein are associated with a PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

In some embodiments, systems disclosed herein can be designed for centralized applications, onsite application, of mobile applications via transportation to a site. The centralized configuration can be employed at a permanent processing plant such as in a permanently installed water treatment facility such as a municipal water treatment system. The onsite and mobile systems can be used in areas of low loading requirement where temporary structures are adequate. A mobile unit may be sized to be transported by a semi-truck to a desired location or confined within a smaller enclosed space such as a trailer, e.g., a standard 53′ trailer, or a shipping container, e.g., a standard 20′ or 40′ intermodal container.

In accordance with an aspect, there is provided a method of treating water containing PFAS. The method may include dosing water containing PFAS with adsorption media to promote loading of the adsorption media with PFAS. The method further may include producing a slurry stream including the PFAS-loaded adsorption media. The method additionally may include subjecting the slurry stream to a SCWO process.

In some embodiments, the PFAS include one or more PFOS and PFOA.

In some embodiments, the adsorption media is a carbon-based media. For example, the carbon-based adsorption media may include activated carbon, e.g., PAC or GAC. In particular embodiments, the carbon-based adsorption media may be PAC. In certain embodiments, the carbon-based adsorption media may include macrocyclic organic compounds such as cyclodextrins, e.g., α-cyclodextrin, β-cyclodextrin, and γ-cyclodextrin. In other embodiments, the carbon-based adsorption media may include heterocyclic molecules, e.g., porphyrins, diatomaceous earth, or neutral and ionic surfactants. In some embodiments, the adsorption media may be inorganic, e.g., alumina, e.g., activated alumina, aluminosilicates and their metal-coordinated forms, e.g., zeolites, silica, perlite, ion exchange resins, and other similar inorganic materials capable of interacting with and subsequently removing contaminants and pollutants from the water containing PFAS.

In some embodiments, the slurry stream including the loaded adsorption media is produced via a filtration and backwash operation. In further embodiments, the method may include concentrating the slurry stream prior to the SCWO process. In further embodiments, the method may include concentrating the water containing PFAS prior to introduction to the adsorption media, e.g., using a membrane concentrator, e.g., with a dynamic membrane. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×.

In further embodiments, the method may include introducing a selective ion to the SCWO process. The selective ion may be chosen to interact with a residual compound remaining following the SCWO process to render it safe for disposal.

In further embodiments, the method may include adjusting the dosage of adsorption media based on at least one quality parameter of the water to be treated. For example, the at least one quality parameter may include a target concentration of the PFAS in the treated water to be at or below a specified regulatory threshold.

In further embodiments, the method may include adjusting a flow rate of the slurry stream and/or an oxygen supply level associated with the SCWO process.

In some embodiments, the SCWO process may be operated at a temperature of at least about 374° C. and a pressure of at least about 221 bar, e.g., greater than or equal to the critical point of water. In some embodiments, the SCWO process is operated under autothermal conditions, i.e., no outside input of heat is required. In further embodiments, the method may include preheating the water containing PFAS and/or the slurry stream upstream of the SCWO process.

In further embodiments, the method may include introducing a product stream, e.g., from the SCWO process, to a downstream unit operation for further treatment.

In further embodiments, the method may include separating byproducts including nitrogen oxides (NOₓ) and/or sulfur oxides (SOₓ) and/or inorganic ash from product water at an outlet of the SCWO process.

In some embodiments, the method may be associated with as PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

In accordance with an aspect, there is provided a method of treating water containing per- and polyfluoroalkyl substances (PFAS). The method may include promoting loading of PFAS from the water containing PFAS onto a removal material having a predetermined calorific value. The method further may include creating a slurry stream including the removal material loaded with PFAS. The method additionally may include subjecting the slurry stream to a SCWO process driven at least in part by a predetermined calorific value of the removal material.

### EXAMPLES

The function and advantages of these and other embodiments can be better understood from the following examples. These examples are intended to be illustrative in nature and are not considered to be in any way limiting the scope of the invention.

### Prophetic Example 1—PFAS Removal by Cyclodextrins

In this example, the ability of different sized cyclodextrins to remove PFAS will be explored. As discussed herein, cyclodextrins can form host-guest or inclusion complexes with organic molecules. The structural properties of cyclodextrins useful as removal materials is provided in Table 1.

TABLE 1
Structural Properties of Common Cyclodextrins

| Type | α | β | γ |
|---|---|---|---|
| # of D-glucopyranose units | 6 | 7 | 8 |
| Molecular Weight (g/mol) | 972 | 1135 | 1297 |
| Solubility in water at 25 C. (% w/w) | 14.5 | 1.85 | 23.2 |
| Outer Diameter (Å) | 14.6 | 15.4 | 17.5 |
| Cavity Diameter (Å) | 4.7-5.3 | 6.0-6.5 | 7.5-8.3 |
| Height of Torus (Å) | 7.9 | 7.9 | 7.9 |
| Cavity Volume (Å³) | 174 | 262 | 427 |

As is seen in Table 1, cyclodextrins have high solubility in water. In order to be useful as a removal material, such as by filtration from a waste stream or by use in a column, the cyclodextrins are to be made insoluble in water such that the complexes can be removed. This change can be effectuated by cross-linking and polymerization of the cyclodextrins or by forming MOFs using the cyclodextrins.

### Cross-Linking

The pendant hydroxyl functional groups of cyclodextrins are to be reacted with diisocyanates such as 2,4-toluene-diisocyanate (2,4-TDI) and 1,6-hexane-diisocyanate (1,6-HDI). After crosslinking, the cyclodextrins become insoluble polymeric structures as illustrated in FIG. 1A. The cross-linking reaction can be carried out in a dry solvent that can dissolve the cyclodextrins. After isolation of the cross-linked cyclodextrins and purification to remove the solvents and other unreacted materials, such as by washing with water, the cross-linked cyclodextrins are to be deployed as a removal material for PFAS removal from a waste stream, e.g., batch mode or continuous mode removal processes. Beyond diisocyanates, other bifunctional molecules that readily react with hydroxyl groups can be used to cross-link the cyclodextrins, including, but not limited to, acid chlorides.

### CD-MOFs

Vapor diffusion method: This method is a simple crystallization process but is time consuming. The reactants are dissolved in a solvent and then through the condensation of the vapors of a non-solvent, the solubility of the product as a consequence decreases and the CD-MOF crystallizes out of the solution. In a typical reaction, 1.30 g of γ-CD and 0.45 g of KOH, were dissolved together in 20 mL of distilled water in a 50 ml beaker to provide a molar ratio of 1:8 of γ-CD to KOH). The molar ratio can be varied to obtain different types of CD-MOF structures and resulting porosities. The 50 ml beaker containing the reactants was placed inside a larger 500 mL beaker and 50 mL of methanol was added. The 500 mL beaker was sealed with parafilm and allowed to stand unperturbed for 5-10 days. Crystals slowly start forming and after they were formed, they were removed by filtration and soaked in methanol for three days to remove unreacted materials. The crystals were activated by heating them in a vacuum oven at room temperature, i.e., 25° C. for 10 hours and further heated at 45° C. for an additional 12 hours. Removal of the methanol and water opened the pores of the CD-MOF that permits is use as a removal material for PFAS and other contaminants and pollutants in a waste stream.

Hydrothermal/solvothermal process: In this process, instead of using the slow crystallization process at room temperature, the reaction mixture of cyclodextrin and an alkali metal salt in water, or in a mixture with organic solvent such as an alcohol, are to be heated to a high temperature, for example, 150° C.-250° C. for 24 hours in a pressure vessel. Crystals of the complex structures will precipitate and can removed by filtration. The resulting crystals are to be purified by washing with water or an organic solvent to remove unreacted materials. The washed crystals are to be dried before use as a removal material of organic and other contaminants from water.

The phraseology and terminology used herein is for the purpose of description and should not be regarded as limiting. As used herein, the term “plurality” refers to two or more items or components. The terms “comprising.” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of treating water containing per- and polyfluoroalkyl substances (PFAS), comprising:
dosing water containing PFAS with adsorption media to promote loading of the adsorption media with PFAS;
producing a slurry stream including the PFAS-loaded adsorption media; and
subjecting the slurry stream to a supercritical water oxidation (SCWO) process.

2. The method of claim 1, wherein the PFAS comprise perfluorooctane sulfonic acid (PFOS) or perfluorooctanoic acid (PFOA).

3. The method of claim 1, wherein the adsorption media is a carbon-based media.

4. The method of claim 3, wherein the adsorption media is a powdered activated carbon (PAC).

5. The method of claim 3, wherein the adsorption media comprises a cyclodextrin (CD).

6. The method of claim 1, wherein the slurry stream is produced via a filtration and backwash operation.

7. The method of claim 1, further comprising concentrating the slurry stream prior to the SCWO process.

8. The method of claim 1, further comprising concentrating the water containing PFAS prior to dosing with adsorption media.

9. The method of claim 1, further comprising introducing a selective ion to the SCWO process.

10. The method of claim 1, further comprising adjusting the dosage of adsorption media based on at least one quality parameter of the water to be treated.

11. The method of claim 1, further comprising adjusting a flow rate of the slurry stream and/or an oxygen supply level associated with the SCWO process.

12. The method of claim 1, wherein the SCWO is operated at a temperature of at least about 374° C.

13. The method of claim 12, wherein the SCWO process is operated at a pressure of at least about 221 bar.

14. The method of claim 1, wherein the SCWO process is operated at autothermal conditions.

15. The method of claim 1, further comprising preheating the water containing PFAS and/or the slurry stream upstream of the SCWO process.

15. The method of claim 1, further comprising delivering product water at an outlet of the SCWO process to a downstream unit operation for further treatment.

17. The method of claim 1, further comprising separating byproducts including nitrogen oxides (NOₓ) and/or sulfur oxides (SOₓ) and/or inorganic ash from product water at an outlet of the SCWO process.

18. The method of claim 1, associated with a PFAS removal rate of at least about 99%.

19. A method of treating water containing per- and polyfluoroalkyl substances (PFAS), comprising:
promoting loading of PFAS from the water containing PFAS onto a removal material having a predetermined calorific value;
creating a slurry stream including the removal material loaded with PFAS; and
subjecting the slurry stream to a supercritical water oxidation (SCWO) process driven at least in part by the predetermined calorific value of the removal material.

20. A system for treating water containing per- and polyfluoroalkyl substances (PFAS), comprising:
a contact reactor containing adsorption media;
a source of water comprising PFAS fluidly connected to an inlet of the contact reactor;
a separation system fluidly connected downstream of the contact reactor; and
a supercritical water oxidation (SCWO) reactor fluidly connected downstream of the separation system.

21. The system of claim 20, wherein the adsorption media is bifunctional with respect to facilitating PFAS removal and driving the SCWO reactor.

22. The system of claim 20, wherein the adsorption media comprises at least one material selected from the group consisting of: activated carbon, cyclodextrins, heterocyclic molecules, porphyrins, diatomaceous earth, neutral surfactants, ionic surfactants, inorganic media, alumina, activated alumina, aluminosilicates, zeolites, silica, perlite, metalorganic complexes and ion exchange resins.

23. The system of claim 21, wherein the separation system comprises a dynamic membrane.

24. The system of claim 23, wherein the dynamic membrane comprises a ceramic membrane.
